(19) United States
(12) Patent Application Publication
(10) Pub. No.: US 2015/0227630 A1
(43) Pub. Date: Aug. 13, 2015

(54) CACHING QUERIES FOR DYNAMIC WEBPAGES

(71) Applicant: Microsoft Corporation, Redmond, WA (US)

(72) Inventors: Helge Grenager Solheim, Oslo (NO); Alexander J. Pope, Oslo (NO); Omar Faruk, Oslo (NO); Anundi Lie, Oslo (NO); Liang Zheng, Oslo (NO)

(73) Assignee: Microsoft Corporation, Redmond, WA (US)

(21) Appl. No.: 14/179,801

(22) Filed: Feb. 13, 2014

(51) Int. Cl. G06F 17/30

(52) U.S. Cl. CPC G06F 17/30867; G06F 17/3048; G06F 17/30893

(57) ABSTRACT

A group of users is defined, and the group is assigned a common set of content access rights. A query executed by one member of the group is executed with the access rights assigned to the group. Results are cached so that if another member of the group executes the same query, the cached results can be returned.

### BACKGROUND

Many computer systems are designed so that a user can view pages of content. For instance, a user may open a browser and navigate to a webpage. The computer displays content for the webpage.

Some webpages are generated on-the-fly. That is, a page contains a search mechanism that automatically issues a query, when a visitor browses to that page. The page is then displayed, with the returned search results. In many cases, users are unaware that search technology is being used to display the content they're viewing.

However, conducting a search can be a somewhat expensive operation, in terms of computing overhead and memory usage. Thus, systems that trigger a search for every page load put a relatively high computing load on the system. This can result in longer page load times and a reduced number of concurrent page loads per second.

Some systems currently cache the entire page. However, if different users have different access rights, then even when they access the same page they will see different results. Thus, caching the entire page for a given user does not alleviate the search load. Some systems also attempt to cache parts of a query, which are later used in query processing. This can make the search operation somewhat less expensive, but the remaining search operations are still relatively costly.

The discussion above is merely provided for general background information and is not intended to be used as an aid in determining the scope of the claimed subject matter.

### SUMMARY

A set of users is defined, and the set is assigned a common set of content access rights. A query executed by one member of the set of users is executed with the access rights assigned to the set of users. Results are cached so that if another member of the set of users executes the same query, the cached results can be returned.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a dynamic search architecture.

FIG. 2 is a flow diagram illustrating one embodiment of the operation of an administrative component in setting up dynamic group caching.

FIGS. 2A-2C are exemplary user interface displays.

FIG. 3 is one exemplary flow diagram illustrating the operation of the architecture shown in FIG. 1 in executing a search.

FIG. 4 shows one embodiment of the architecture shown in FIG. 1, deployed in a cloud computing architecture.

FIGS. 5-9 show exemplary mobile devices.

FIG. 10 is a block diagram of one illustrative computing environment.

### DETAILED DESCRIPTION

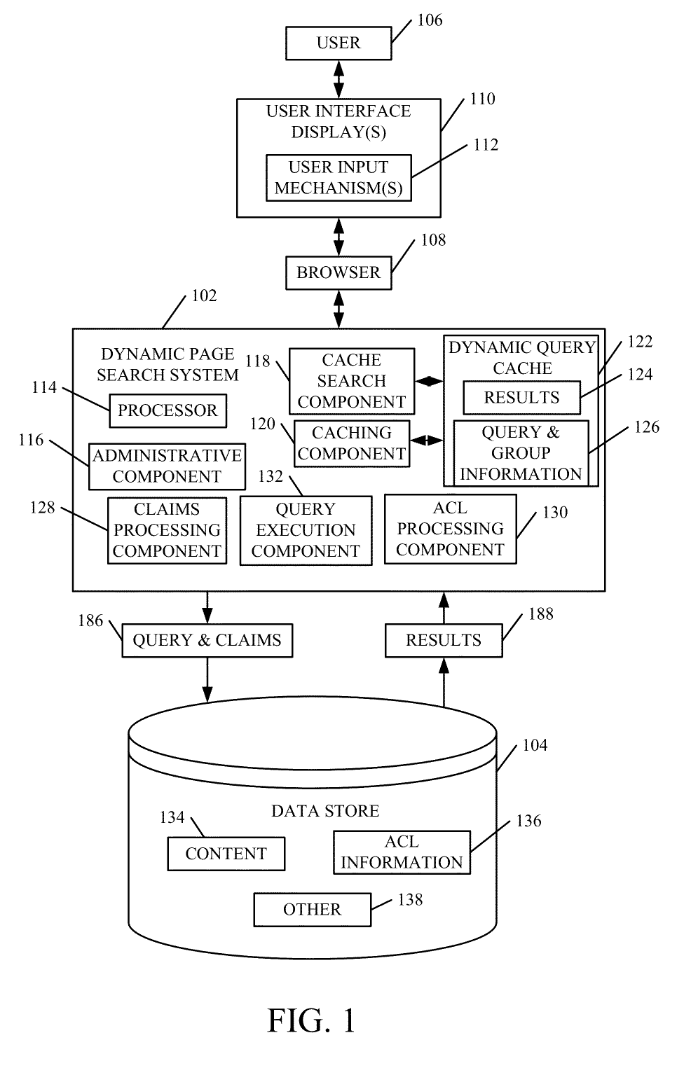

FIG. 1 is block diagram of one embodiment of a dynamic search architecture 100. Architecture 100 shows dynamic page search system 102 that has access to data store 104. A user 106 accesses system 102 through a browser 108. Browser 108 illustratively generates user interface displays 110, with user input mechanisms 112, for interaction by user 106. User 106 illustratively interacts with user input mechanisms 112 to control and manipulate browser 108 and system 102.

FIG. 1 shows that, in one embodiment, dynamic page search system 102 includes processor 114, administrative component 116, cache search component 118, caching component 120, dynamic query cache 122 (which, itself, includes search results 124 along with query and group information 126 that corresponds to the search results 124), claims processing component 128, access control list (ACL) processing component 130 and query execution component 132. FIG. 1 also shows that data store 104 illustratively includes content 134, ACL information 136 and it can include other information 138 as well.

It should be noted that the present discussion proceeds by using the term “group” of users. However, the term “group” is not to be limited to a conventional user-group membership. Instead, it is meant to refer to a set of users. The set can be identified by any type of membership, such as by all having the same content access right or security claim. That right or security claim can be a wide variety of different things, such as membership in a conventional group, geographical presence at a given location, being present within a certain time frame (such as having given working hours), or a variety of other things, some of which are mentioned below.

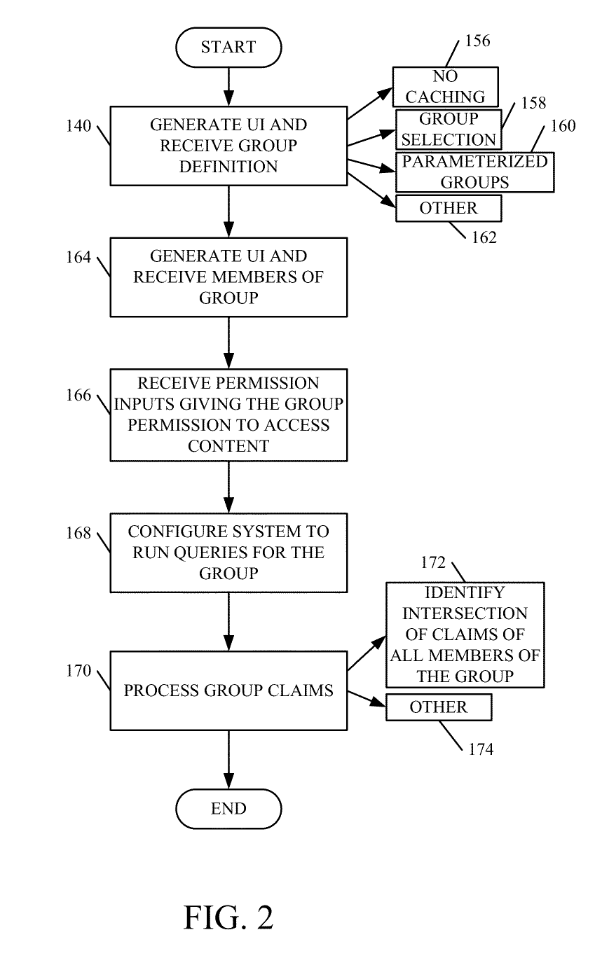

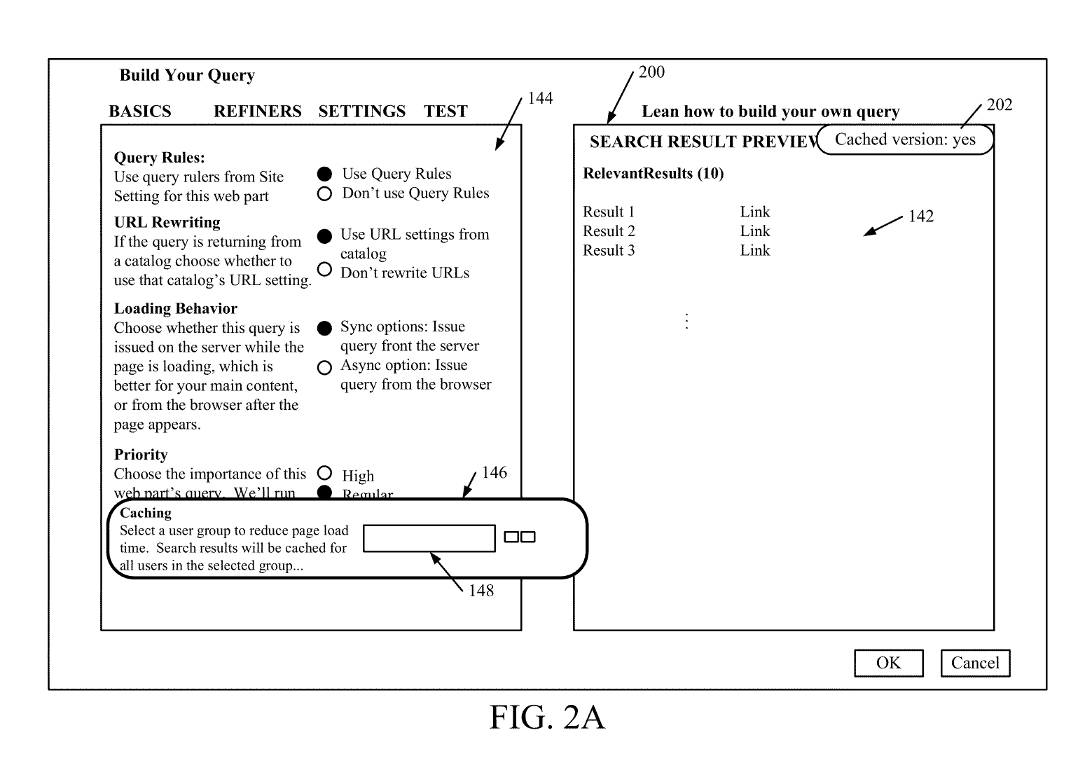

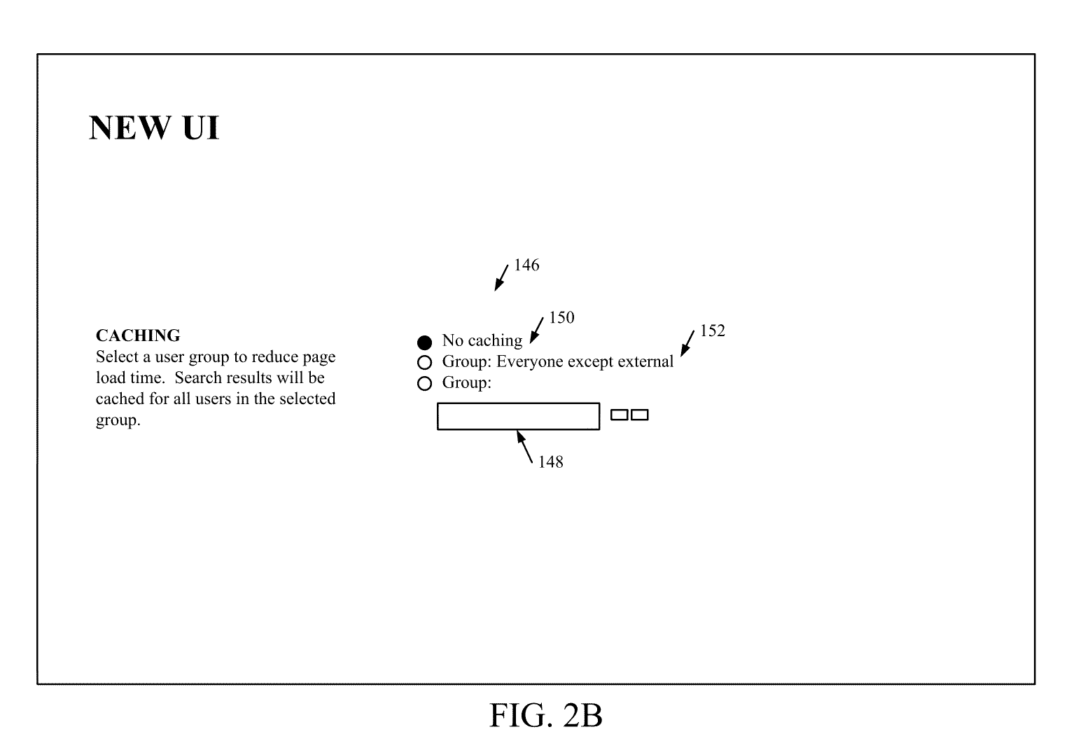

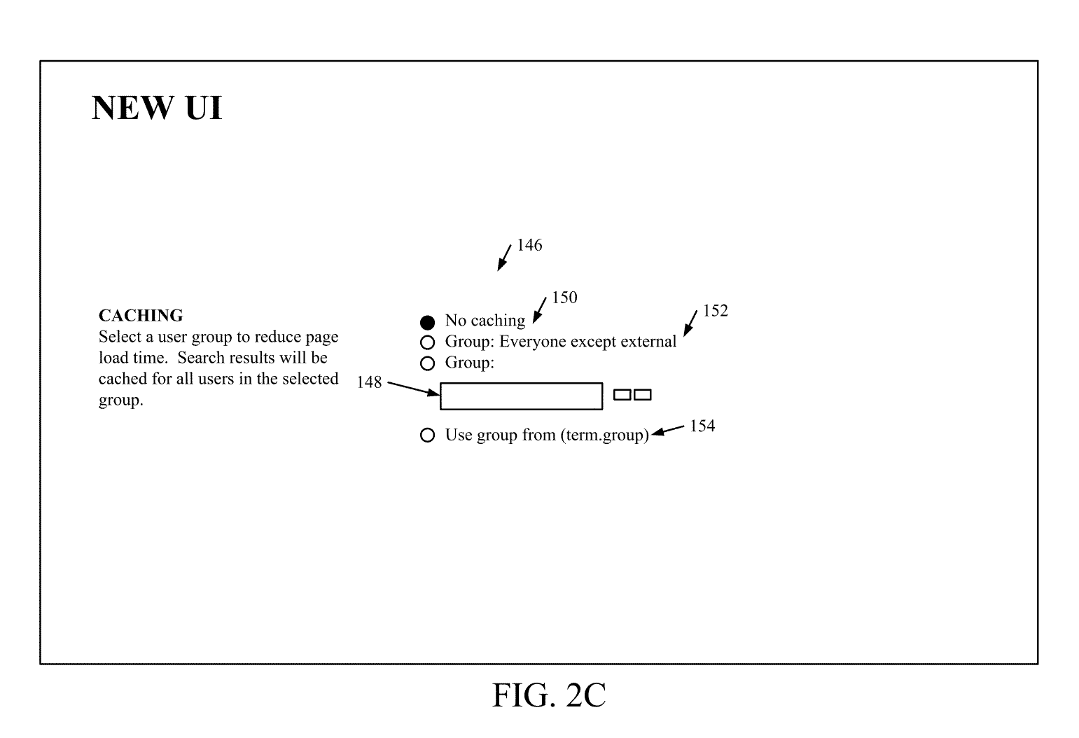

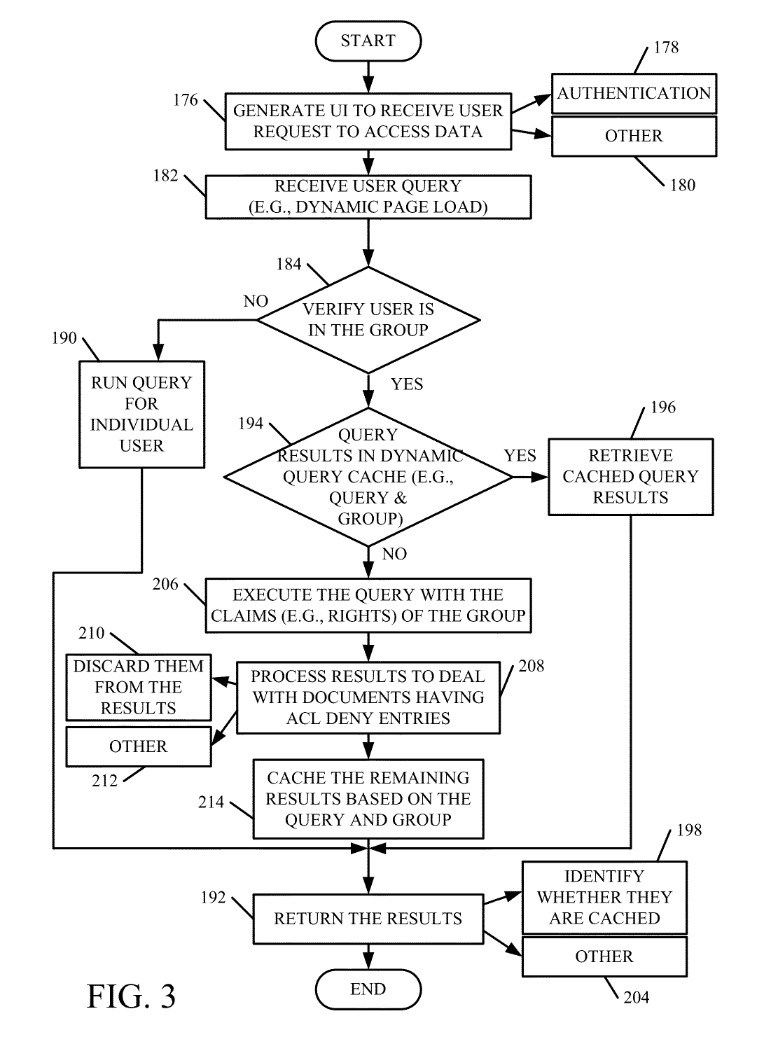

Before describing the overall operation of architecture 100 in more detail, a brief overview will be provided. An administrator illustratively access administrative component 116 to identify a set of individual users that commonly access the same content 134 (e.g., the same dynamic webpage). The administrator configures a group that has the set of users as members. The administrator then configures system 102 so that, when a member of the group attempts to access a dynamic webpage (such as on page load), query execution component 132 can execute the query for the entire group, and not just that individual user. Caching component 120 then stores the results 124 of the query, along with the query itself, and the group information identifying the group for which the query was executed. Then, when another user 106, that is part of the same group, accesses the dynamic webpage, cache search component 118 will determine that the query for content on that page, for this given group, has already been executed and is cached in dynamic query cache 122. Therefore, the cached results can be returned to browser 108, instead of requiring query execution component 132 to execute a new query against data store 104. The operation of architecture 100 in allowing an administrator to configure groups is described in greater detail below with respect to FIGS. 2-2C. The operation of architecture 100 in processing queries for users that are members of various groups is described in greater detail below with respect to FIG. 3. FIGS. 1-2C (showing administration of groups) will now be described in conjunction with one another.

An administrator first accesses administrative component 116 in system 102. This can be done, for example, by providing authentication information or other information to gain access to system 102, as an administrator. Administrative component 116 then generates a user interface display for the administrator so that the administrator can input a group definition. This is indicated by block 140 in FIG. 2. FIG. 2A shows one embodiment of a user interface display 142, that allows the administrator to do this.

It can be seen that, in one embodiment, user interface display 142 illustratively includes a query configuration portion 144 that allows the administrator to set various parameters or settings, that control how queries are executed for loading a dynamic webpage. In one embodiment, portion 144 illustratively includes a caching configuration portion 146. Caching configuration portion 146 illustratively includes a user input mechanism 148 (such as a text field) that allows the user to input, or select, a group for which search results will be cached.

FIG. 2B shows another embodiment of caching configuration portion 146. It can be seen in FIG. 2B that portion 146 includes the group identifier user input mechanism 148, but it also includes selectable user input mechanisms 150 and 152 which can be selected by the administrator to have the system perform no caching, or to cache search results for everyone except external users, respectively.

FIG. 2C shows yet another embodiment of caching configuration portion 146. It can be seen that some of the items in FIG. 2C are similar to those shown in FIG. 2B and are similarly numbered. However, portion 146 in FIG. 2C also includes a parameterization user input mechanism 154. By way of example, by selecting user input mechanism 154, the administrator can specify a parameterized group, either with a free-text expression or selecting from some pre-defined expressions. That is, the group that is used for caching varies based upon some dynamic expression that is valued for every query-user combination. By way of example, the group expression may be {term.group} or any other expression that extract text or tokens from the URL, user context, navigation structure or similar, and thus uses a group name which is the same as the term that was used to navigate to the page. The “group” is thus a custom property on “term” defined by the administrator and thus varies from term to term, and is used by system 102, at runtime.

Referring again to the flow diagram of FIG. 2, an example of a user interface that allows the administrator to choose no caching is indicated by block 156. A user interface that allows the administrator to select a group is indicated by block 158, a user interface that allows the administrator to select a parameterized group is indicated by block 160 and defining groups in other ways is indicated by block 162.

Once the administrator has defined a group or selected an existing group, the administrator illustratively provides inputs through a suitable user interface display to identify the various individual members of that group. This is indicated by block 164 in the flow diagram of FIG. 2. The administrator then provides permission inputs giving the newly created group, with its newly identified membership, permissions to access various content within data store 104. This is indicated by block 166 in the flow diagram of FIG. 2.

Once the group has been configured and the members of the group have been identified and the group has been permitted to access certain content, the administrator configures system 102 to run queries for the group. This is indicated by block 168 in FIG. 2. This can be done in a wide variety of different ways. For instance, the various groups, their corresponding memberships and their permissions can be stored for later access by system 102 during query processing. Also, the administrator can identify to query execution component 132 that when a query from a member of the group is received, the query should be run for the group, as a whole, instead of for that individual user. Administrative component 116 can configure the system in other ways as well.

Claims processing component 128 (in FIG. 1) then identifies the claims associated with the newly defined group. By way of example, each user will have a set of claims associated with that user. Each claim represents a right that the user has. For example, each claim may represent a group that the user belongs to. In one specific example, for instance, system 102 can be used in conjunction with, or as part of, a business system such as an enterprise resource planning (ERP) system, a customer relations management (CRM) system, a line-of-business (LOB) system or another type of business system. In such an implementation, a particular user may have a claim indicating that the user is part of the human resources (HR) group of an organization. This “claim” will entitle the corresponding user to have access to certain content 134 within the data store 104 for the business system or organization.

In processing the claims (or content access rights) for the newly defined or existing group, claims processing component 128 illustratively identifies a set of claims that can be applied to the entire group. Identifying which claims should be associated with the newly defined or existing group is indicated by block 170 in the flow diagram of FIG. 2. If the group is an existing group, then the claim can be identified in several ways. For instance, the existing claim for that group can simply remain the same. In another embodiment, component 128 can figure out, based on the users and their access rights, which group or set of groups is appropriate and suggest this to the administrator or automatically create a new group. Regardless of how the claim or claims are assigned to the group, component 128 illustratively does this in such a way that no member of the group has access to information that they would not otherwise have access to. For instance, in one embodiment, component 128 does not allow the group to have any access rights associated with it that do not already belong to every member of the group. As an example, component 128 can identify the intersection of the set of claims of all members of the group. That is, component 128 can identify the set of claims that all members of a newly defined group have in common. This is indicated by block 172 in FIG. 2. Component 128 can identify the group claims in other ways as well, and this is indicated by block 174.

Having configured the group, its members and permissions, having configured system 102 to run queries for members of the group, on behalf of the group instead of the individual members and having identified a set of claims for the group, system 102 is now ready to perform dynamic page searching for that group. FIG. 3 is a flow diagram illustrating one embodiment of the operation of architecture 100 in performing dynamic webpage searching.

Browser 108 first generates a user interface display that allows user 106 to request access to data in data store 104. This is indicated by block 176 in FIG. 3. The user 106 can illustratively input authentication information (such as a username and password) as indicated by block 178, or other information as indicated by block 180. User 106 then provides an input navigating to a dynamic webpage that uses system 102 to execute a query to load content on the webpage, when the user accesses the webpage. For instance, user 106 may be a member of the HR department within the business system that uses system 102, and user 106 may have navigated to a personnel page within the business system. In that case, browser 108 issues a dynamic page load query in system 102 that obtain the content for the personnel page. Receiving the query from browser 108 (such as a request for a dynamic page load) is indicated by block 182 in the flow diagram of FIG. 3.

The query illustratively includes an identifier, that identifies the specific user 106 that is requesting access to the dynamic webpage. System 102 thus first determines whether the given user is in a group that has been configured by the administrator. This is indicated by block 184 in FIG. 3. If the user is not part of any group, then query execution component 132 simply executes the query (186 in FIG. 1) based on the claims associated with the individual user 106 against data store 104. Component 132 receives the search results 188 and returns the results to user 106, through a user interface display 110 generated by browser 108. Running the query for the individual user 106 is indicated by block 190 in FIG. 3 and returning the search results is indicated by block 192.

If, at block 184, it is determined that the user is a member of a group that has been configured within system 102, then cache search component 118 determines whether the same query has recently been run for another member of the group, and has been stored in dynamic query cache 122. This is indicated by block 194 in FIG. 3.

Continuing with the example, in which user 106 is a member of the human resources group that has been configured within system 102, then if another member of the human resources group has recently accessed the dynamic webpage that user 106 is currently attempting to access, then the search results for that webpage (i.e., for that query) and for the human resources group will have recently been returned to a different member of the group. In that case, caching component 120 will have stored them as results 124, along with the query and group information that identifies the particular query and group for which the results were returned, in cache 122. Thus, at block 194, cache search component 118 will determine that the search results that user 106 is currently requesting are indeed already stored in dynamic query cache 122. Cache search component 118 will thus retrieve the results from dynamic query cache 122 and return them to user 106, through browser 108. This is indicated by block 196 in FIG. 3, and it can be done without having query execution component 132 execute another query against data store 104. This can save a significant amount of query processing during dynamic page loads.

When the results are returned to user 106, in one embodiment, the user interface display that returns the query results from cache 122 indicates that the results are from cache 122. Identifying whether the query results are from cache, or from a new search, is indicated by block 198. FIG. 2A shows one embodiment of this. On the right hand side of user interface display 142, one exemplary view of returned search results (a preview) is indicated by block 200. It can be seen that a user interface display element 202 indicates whether the search results that are previewed in display portion 200 are from cache. The search results can be returned in other ways as well, and this is indicated by block 204 in the flow diagram of FIG. 3.

Returning again to block 194 in FIG. 3, if cache search component 118 determines that there are no cached search results for this query and group, then query execution component 132 executes the query with the claims (e.g., the content access rights) of the group to which user 106 belongs. This is indicated by block 206 in FIG. 3.

In doing so, component 132 illustratively takes into account the access control list information 136. For example, in one embodiment, each item of content 134 has access control list information 136 associated with it. This information identifies the various claims (e.g., groups) or individuals that have access to this item of content, and it may also include the identity of users or groups that are denied access to the corresponding item of content. Thus, when component 132 obtains search results 188, it obtains only the content 134 that corresponds to the claims that are associated with the query being executed (e.g., the claims associated with the group to which user 106 belongs). In addition, ACL processing component 130 illustratively removes from search results 188 any items of content (e.g., documents) that have any ACL deny information. That is, if any item of content in results 188 has an ACL entry that indicate that the item of content is denied to any users, that item of content is illustratively removed from results 188 before they are provided to user 106. This insures that no user 106 is obtaining any information by virtue of belonging to a group, in system 102, that they shouldn't be obtaining. Having ACL processing system 130 process results 188 to deal with documents that have ACL deny entries is indicated by block 208 in FIG. 3. Discarding those documents or removing them from results 188 before the results are presented to the user is indicated by block 210, and dealing with documents or items of content that have ACL deny entries in other ways is indicated by block 212.

Caching component 120 then caches the results 188 (after the items of content with ACL deny entries have been dealt with) in dynamic query cache 122, along with the particular query and group information that identifies the query and the group for which the query was executed. Caching the results is indicated by block 214 in FIG. 3. In this way, if either user 106, or another user that is a member of the same group as user 106, requests a dynamic page load for the same page (e.g., so that the query and group are the same) then the search results can be returned by cache search component 118, from cache 122, instead of executing a new query against data store 104. Again, this saves processing overhead and memory usage associated with executing queries against data store 104.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

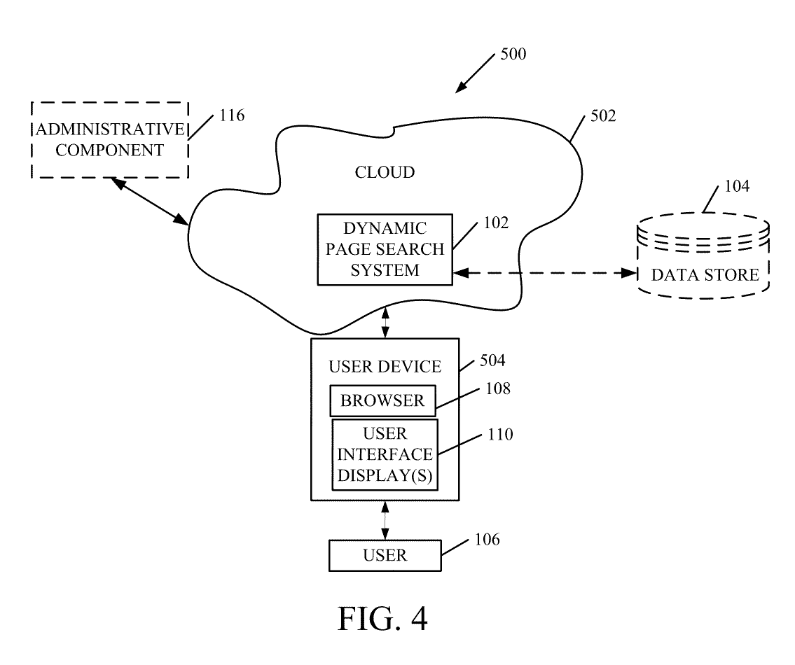

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that dynamic page search system 102 can be located in cloud 502 (which can be public, private, or a combination where portions are public while others are private). Therefore, user 106 uses a user device 504 that can include browser 108 to access those systems through cloud 502.

FIG. 4 also depicts another embodiment of a cloud architecture. FIG. 4 shows that it is also contemplated that some elements of architecture 100 can be disposed in cloud 502 while others are not. By way of example, data store 104 can be disposed outside of cloud 502, and accessed through cloud 502. In another embodiment, administrative component 116 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

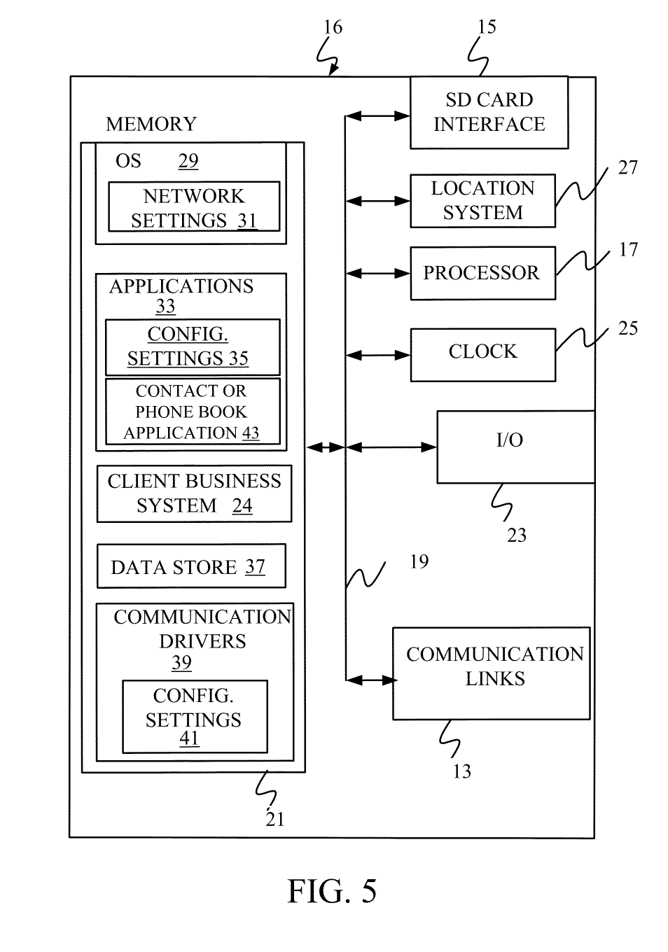

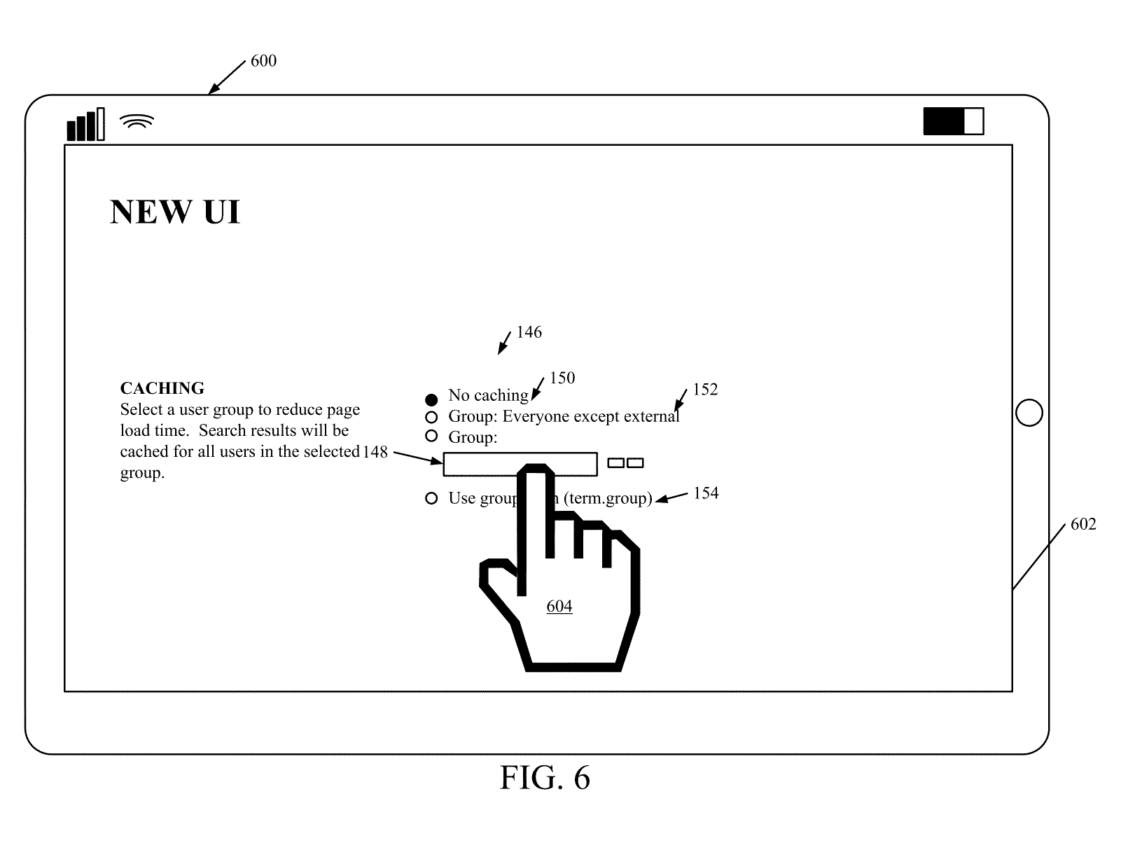

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 102 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 114 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with the user interface display from FIG. 2C displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

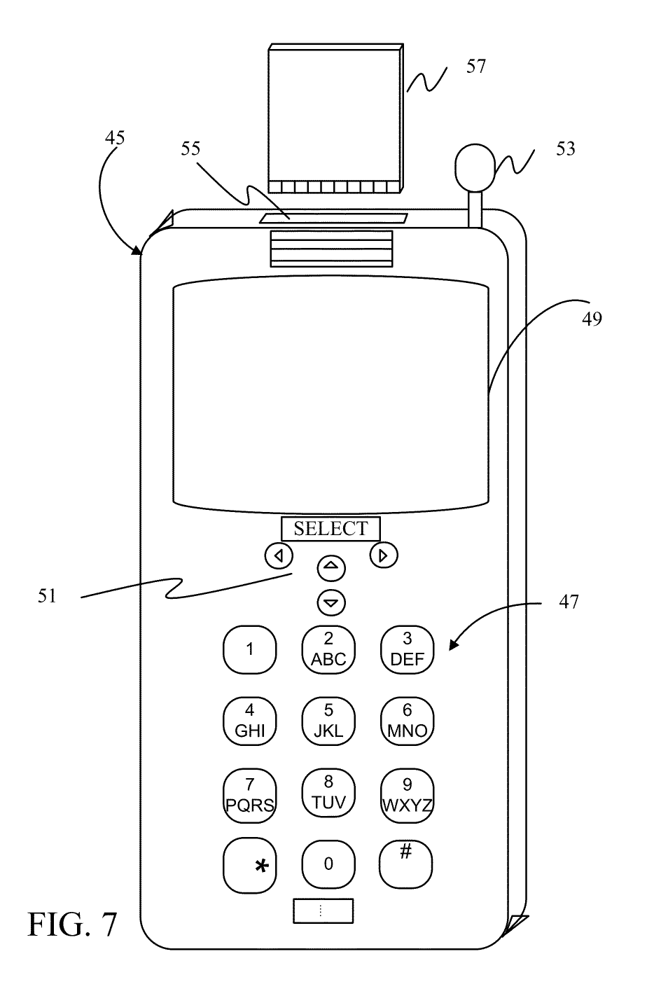

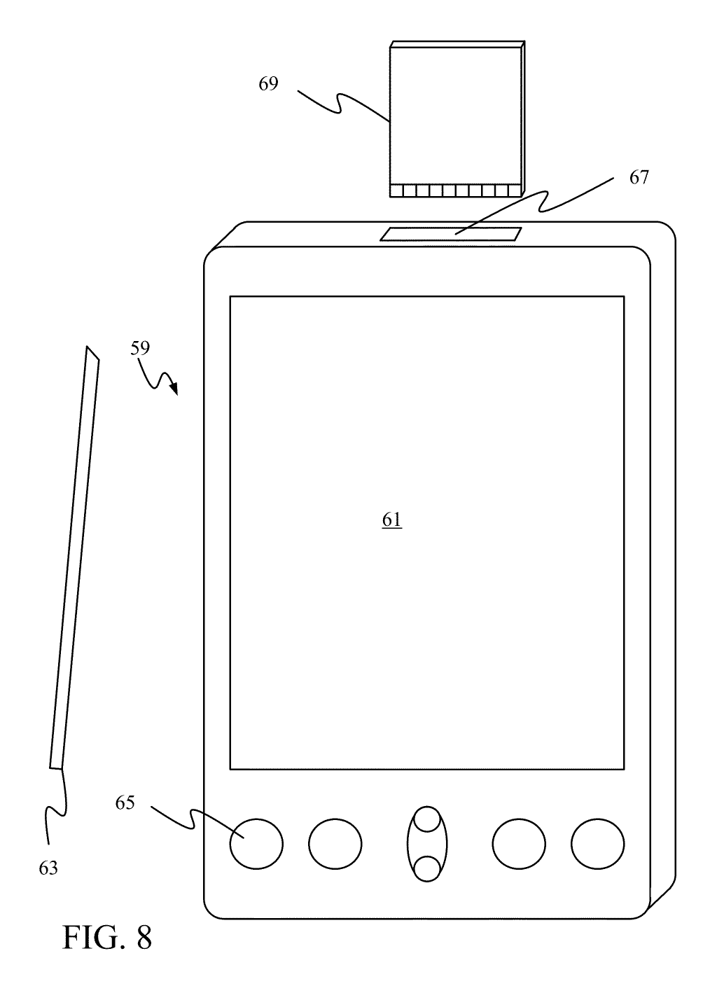

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

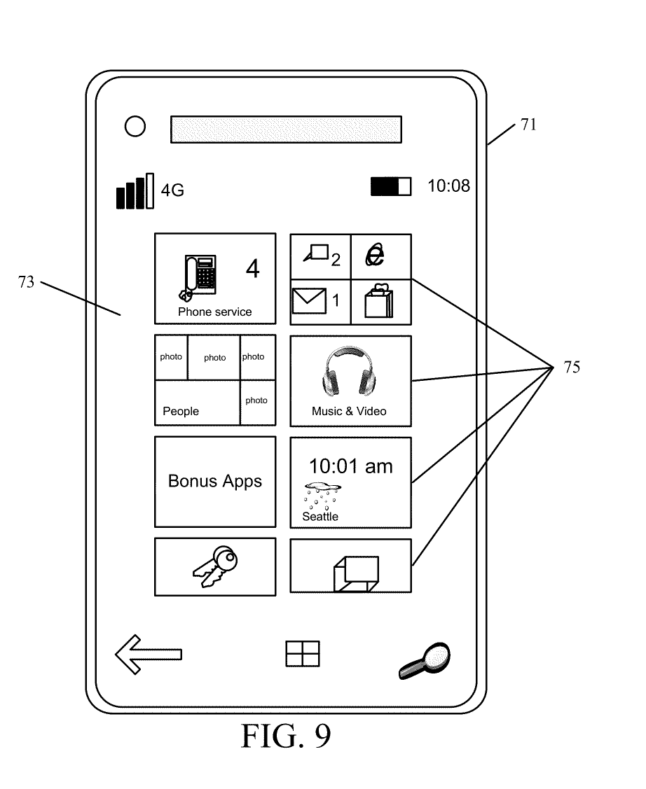

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

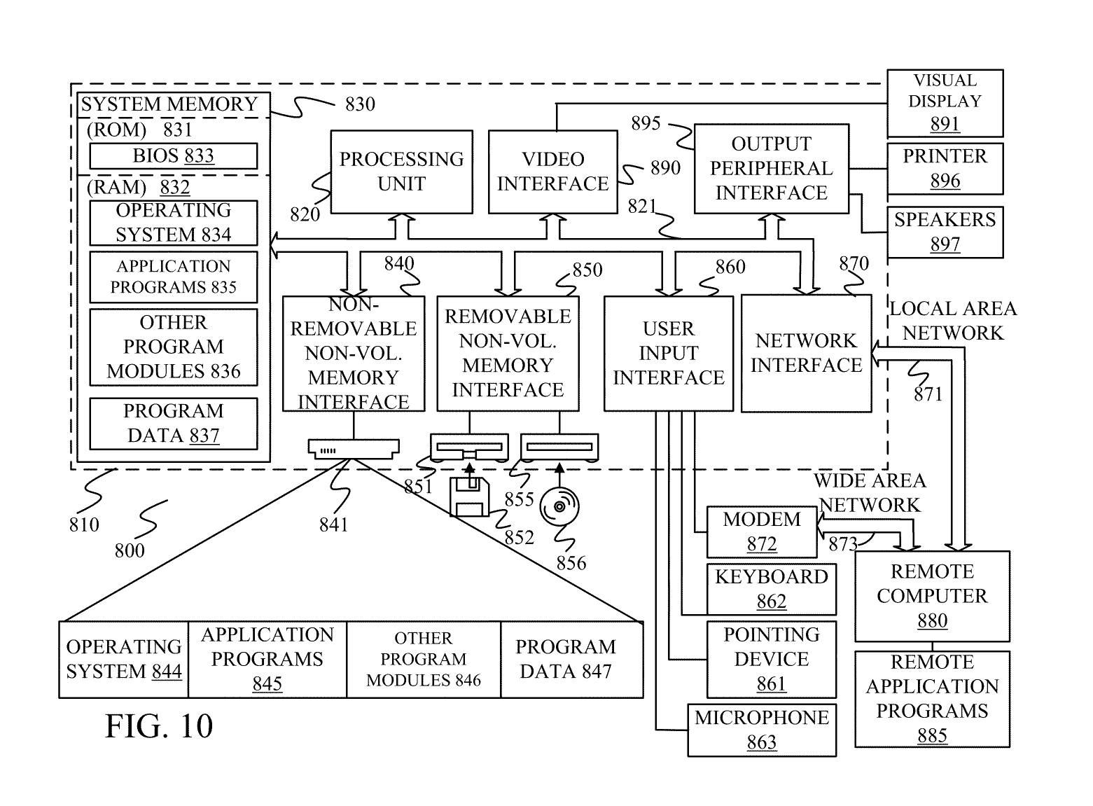

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 114), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
determining whether a query for content to load to a dynamic page corresponds to a user that belongs to a group;
if the user belongs to the group, returning the content to load to the dynamic page, based on claims corresponding to the group; and
caching the content along with a query indicator indicative of the query and a group indicator indicative of the group the user belongs to.

2. The computer-implemented method of claim 1 and further comprising:
determining whether a subsequent query for the content to load to a dynamic page corresponds to a user that belongs to the group; and
if so, identifying the content in cache based on the query and the group; and
returning the content from cache.

3. The computer-implemented method of claim 2 wherein returning the content to load to the dynamic page, based on claims corresponding to the group, comprises:
executing the query against a content store to identify responsive items of content that are accessible, given the claims corresponding to the group.

4. The computer-implemented method of claim 3 wherein returning the content comprises:
identifying any of the items of responsive content that have access control list entries that deny access; and
if so, removing the identified items of content from the content, prior to returning and caching the content.

5. The computer-implemented method of claim 1 and further comprising:
if the user does not belong to a group, then executing the query against a content store using the claims of the user.

6. The computer-implemented method of claim 1 and further comprising:
generating a group configuring user interface display with a user input mechanism that receives group configuration user inputs to define the group and a set of users that are members of the group; and
identifying the claims corresponding to the group based on the set of users that are members of the group.

7. The computer-implemented method of claim 6 wherein the user input mechanism comprises a group selection user input mechanism that receives a group selection user input selecting a group.

8. The computer-implemented method of claim 6 wherein the user input mechanism comprises a parameterized group definition input mechanism that receives a user input defining a parameterized group.

9. The computer-implemented method of claim 6 wherein identifying the claims corresponding to the group comprises:
identifying the claims corresponding to the group based on content access rights of each of the users in the set of users that are members of the group.

10. The computer-implemented method of claim 9 wherein identifying the claims corresponding to the group comprises:
identifying the claims corresponding to the group as a set of content access rights common to all users in the set of users that are members of the group.

11. The computer-implemented method of claim 2 wherein returning the content from cache comprises:
displaying a visual display element indicative of whether the content is returned from cache.

12. A computer system, comprising:
a query execution component that receives queries for content to load a dynamic page, each given query corresponding to a given user, the query execution component identifying a set of access rights for a given group of users that includes the given user and executing the given query using the access rights for the given group to obtain results that include the content;
a caching component that stores the results, the given query that generated the results and a group identifier that identifies the given group, in a dynamic query cache;
a cache search component that receives each given query and determines whether the dynamic query cache has results for the given query and the given group and, if so, returns the results for the given query from the dynamic query cache; and
a computer processor that is a functional part of the system and is activated by the cache search component to facilitate determining whether the dynamic query cache has the results and returning the results.

13. The computer system of claim 12 and further comprising:
an access control list (ACL) processing component that identifies items in the results that have access control entries that deny access to a user and that removes the identified items from the results prior to caching and returning the results.

14. The computer system of claim 12 and further comprising:
an administrative component that generates user interface displays that receive user inputs to define the given group and members of the given group.

15. The computer system of claim 14 and further comprising:
a claims processing component that calculates the set of access rights for the given group based on access rights of the members of the given group.

16. The computer system of claim 15 wherein the claims processing component calculates the set of access rights for the given group as an intersection of the access rights of all of the members of the group.

17. A computer readable storage medium that stores computer executable instructions which, when executed by a computer, cause the computer to perform a method, comprising:
generating a group configuring user interface display with a user input mechanism that receives group configuration user inputs to define a group within a computer system and a set of users that are members of the group;
identifying content access rights corresponding to the group based on content access rights for the set of users that are members of the group;
receiving a first query for content to load into a dynamic web page;
determining whether the first query corresponds a user that is a member of the group;
if the user is a member of the group, searching for the content based on the content access rights corresponding to the group;
caching the content along with a query indicator indicative of the first query and a group indicator indicative of the group; and
returning the content to load to the dynamic web page.

18. The computer readable storage medium of claim 17 and further comprising:
receiving a subsequent query;
determining whether the subsequent query is a same query as the first query and whether the subsequent query corresponds to a user that is a member of the group; and
if so, identifying the content in cache based on the query indicator and the group indicator; and
returning the content from cache.

19. The computer readable storage medium of claim 18 wherein generating the group configuring user interface display with the user input mechanism comprises:
displaying a group selection user input mechanism that receives a group selection user input selecting a group.

20. The computer readable storage medium of claim 18 wherein generating the group configuring user interface display with the user input mechanism comprises:
displaying a parameterized group definition input mechanism that receives a user input defining a parameterized group.
